(19) United States
(12) Patent Application Publication
(10) Pub. No.: US 2018/0126676 A1
(43) Pub. Date: May 10, 2018

(54) LOAD APPLICATION ELEMENT AND METHOD TO PRODUCE A LOAD APPLICATION ELEMENT

(71) Applicant: MUBEA CARBO TECH GMBH, Salzburg (AT)

(72) Inventor: Sebastian SCHMITZ, Salzburg (AT)

(73) Assignee: MUBEA CARBO TECH GMBH, Salzburg (AT)

(21) Appl. No.: 15/572,094

(22) PCT Filed: Apr. 26, 2016
(86) PCT No.: PCT/EP2016/059286

§ 371 Date: Nov. 6, 2017

(30) Foreign Application Priority Data
May 8, 2015 (CH) 00636/15

(51) Int. Cl. B29C 70/74; B29C 45/14; B29C 70/22; F16B 37/04

(52) U.S. Cl. CPC B29C 70/745; F16B 37/04; B29C 70/222; B29C 45/14631

(57) ABSTRACT

The invention is directed to a load application element (1) which comprises at least one reinforcing element (3) that comprises a layered setup from several layers of a composite material. The reinforcing element (3) is at least partially encompassed by an outer housing (2).

The present invention is directed to a load application element and to a method to produce a load application element.

### BACKGROUND OF THE INVENTION

In the majority of applications force introduction into composite structures, such as made from fiber reinforced plastics, turns out to be challenging when compared to force introduction into structures made from more conventional materials. One reason for this is that many composite materials are highly anisotropic, as well as relatively brittle when compared e.g. to conventional metal alloys. Consequently, structures made from such materials may be highly sensitive to the way how forces are introduced into them. For example drilling of holes and subsequent thread cutting in order to obtain force transmission points is in general not applicable because the structural weakening introduced by such measures is much higher in most composite structures than it is in conventional materials.

Therefore a variety of specific devices is known from the prior art in order to apply forces to composite structures without critically decreasing their structural competence. A first group of such load application elements is known as “onserts”. Load application elements may also be referred to as “fittings”. Onserts are usually connected to the surface of a composite structure using adhesives and/or a mechanical restraint devices. Hence an external force can be applied to the onsert and will be transmitted across the adhesive into the composite structure. Consequently, onserts are mostly applied to at least partially completed composite structures. A second group of load application elements is at least partially embedded in the composite structures. Such types of load application elements—also known as “inserts”—will usually already be positioned in the composite structures during their production.

U.S. Pat. No. 5,079,055 was published on 7 Jan. 1992 on behalf of Brian P. Doyle and discloses a reinforcement for laminate synthetic materials that comprise two laminate layers which are bonded to one another. According to U.S. Pat. No. 5,079,055, such reinforcements can be used in order to establish more durable attachments of fastening devices, such as bolts or rivets. Said reinforcement comprises a body which is formed from a synthetic plastic material that is compatible with the synthetic plastic material of the laminates. Furthermore, the reinforcement is adapted to be bonded between the laminate layers of the laminate synthetic material. A reinforcement according to U.S. Pat. No. 5,079,055 comprises a plurality of reinforcement fibers that are either arranged in parallel to the laminate layers or perpendicular to them. The fibers arranged in parallel to the laminate layers are intended to distribute stresses applied to the reinforcement throughout the laminate layers, whereas the fibers arranged perpendicular to them are intended to withstand stresses applied to the reinforcement essentially in perpendicular to the laminate layers. U.S. Pat. No. 5,079,055 further describes embodiments of the reinforcement that have openings to receive securing means, such as inserts made e.g. from metal and which may have a threaded interior.

DE10148950 was published on 24 Apr. 2003 on behalf of EADS Deutschland GmbH and describes a carbon reinforced fiber structure which comprises a tubular load application element. According to said publication, the load application element is made from multiple layers of carbon fiber braided hoses. One end of the load application element is formed as a flange and is positioned between two layers of a generally laminar base structure made from a carbon fiber reinforced material. The load application element is connected to the base structure during infusion and subsequent curing of a resin matrix.

US2009/0301644 was published on 10 Dec. 2009 on behalf of Georges Cahuzac et al. and shows a monolithic reinforcement insert which may be used for composite structures. According to this application a reinforcing insert comprises superposed fiber layers which are embedded in a hardened resin and which are joined together by a joining fiber that crosses through said layers so as to form fiber sections which are also embedded in hardened resin. A variety of alignments of theses layers as well as volume percent of layers and materials are described. According to the publication such reinforcing inserts can be tooled to desired forms as well as they can be pierced and threaded such that they can be used in combinations with screws or other fastening elements. The document further discloses a process for producing such reinforcing inserts.

### DESCRIPTION OF THE INVENTION

The load application elements known from the prior art have several drawbacks which, depending on the application, can turn out to be critical.

As for lightweight structures, which is an important field of application of composite structures, load application elements may contribute substantially to the total weight of a component part. This particularly holds true for load application elements made from metals, which still constitute the most widely used type of load application elements. As explained above, many composite structures are relatively sensitive to the way how they are loaded which often makes it necessary to distribute external forces that have to be applied to a composite structure over a larger area of the structure. In such applications the minimum spatial dimensions of a load application element may be mostly given by the loading case as well as the type of composite structure. Thus, the weight of a load application element may mainly depend on the specific weight of the material the load application element is made from.

Aluminum is commonly used for load introduction elements as it has a relatively low specific weight when compared to other metals. However, when compared to most composites materials, aluminum in contrast has a relatively high specific weight. In addition can induce galvanic corrosion to an attached structure made from carbon fiber reinforced plastics. Such corrosion phenomena reduce the mechanical competence and longevity of composite structures. In the prior art, electrochemical incompatibility is usually suppressed by relatively extensive shielding and sealing of the electrochemically incompatible materials.

Other materials characterized by relatively low specific weights, such as continuum plastics or short-fiber reinforced plastics usually have a rather low mechanical competence.

In addition, in order to maximize the structural competence of the region where external loads are applied to a composite structure, the structural anisotropy of a composite structure should be taken into account. However, using load application elements made from isotropic materials (e.g. metals) often makes it difficult to comply with the anisotropic mechanical characteristics of composite structures. Anisotropy can to a certain extent be controlled by modifying the size and shape of a force introducing element made from isotropic materials. However this often requires relatively complex shapes and therefore is not feasible for large-lot production at low prices.

It is therefore one object of the present invention to provide a mechanically competent load application element for composite as well as non-composite structures which has a relatively low weight when compared to the load application elements known from the prior art. The load application element is normally attached to composite and/or non-composite structures is foreseen to exchange load therewith.

It is a further object of the present invention to provide a load application element which may reduce corrosion phenomena when used in combination which composite structures. And it is a further object of the present invention to provide a load application element which can provide a load-case specific distributed force introduction into a composite structure.

Load application elements for high extraction/pull-out forces are normally made from isotropic or almost/quasi isotropic materials and have a relatively simple geometry. They are heavy and bulky and tend to corrosion. The invention provides a solution to solve this problem in that the high forces are absorbed and distributed in a reinforcing element and from there transferred directly or indirectly to the external structure mechanically interconnected to the load application element. A load application element according to the invention therefore comprises at least one reinforcing element that comprises a layered setup from several layers of a composite material. If appropriate layers of other material can be added, e.g. layers of metal.

For some purposes, the load application element may also comprise an outer housing which encompasses the reinforcing element at least partially as described herein after. Thus introduced forces may be at least partially transferred by the outer housing to the external structure. In another variation of the present invention the outer housing may comprise reinforcing ribs in order to increase the mechanical competence of the outer housing and/or to control load transfer from the outer housing to an adjacent structure. For certain applications the load application element may comprise a loading means which may be mechanically interconnected to and/or incorporated in the at least one reinforcing element, as will be explained in detail below. In a variation of the invention the load application element may comprise multiple loading means.

According to an aspect of the invention the applied loads are introduced in the reinforcing element and from there spatially distributed to the surrounding structure attached to the load application element in an efficient manner when compared to the devices known from the prior art. Due to the layered composite material, the distribution of the loads can efficiently be controlled and be adapted to the direction and magnitude of applied forces as well as to the local characteristics of an adjacent mechanical structure. Load distribution can be controlled by multiple means, including outer dimensions and geometry of the reinforcing element as well as the layup of the reinforcing element—e.g. sequential arrangement and individual orientation of the layers—as well as the choice of the fibers. Alternatively or in addition, the wall thickness of an outer housing—if present—may be used in order to control load distribution and form part of the load path.

Hence, according to the invention load application elements can relatively easily be tailored to the loads to be handled as well as the mechanical properties of a structure the loads have to be introduced to. This can be achieved through interaction between different materials as described herein.

Load application elements according to the invention are not limited to certain shapes and hence the reinforcing elements may e.g. have a rectangular, circular, pyramidal, oval or star-like shape.

In a variation of the invention the load application element comprises a loading means that is made from a metal or a ceramic or plastic or a fiber reinforced plastic (or incorporated therein). Particularly lightweight as well as low-cost load application elements may be obtained if the loading means are made from short fibers reinforced plastics.

Good results may be obtained if an outer housing is made from a plastic material with or without fibers. Hence, an outer housing may be made using e.g. injection molding or compression molding processes or thermoforming, as will be described in further details below.

In order to reduce corrosion phenomena, the load application element may comprise an outer housing that is at least partially made from a plastic material which has a sufficiently high electrical resistance. As such, an outer housing may e.g. be made from polyethylene, such as high density polyethylene or polypropylene.

In order to increase the stiffness of an outer housing, in a variation of the invention an outer housing made from a plastic material comprising short fibers may be used. Both, economically and ecologically advantageous load application elements may be obtained if the reinforcing element and/or an outer housing—of present—comprises fibers made from recycled material and/or cut/trim scrap. Thus particularly cut/trim scrap can efficiently be recycled.

Good results may be obtained using short fibers chosen from the group consisting of glass fibers, basalt fibers or aramide fibers. Compared to e.g. carbon fibers, these fibers have a relatively high electrical resistance. Hence a variation of the invention that has an outer housing comprising a plastic which is reinforced by fibers of one or multiple of these materials, may offer both high mechanical coma) petence and very good protection against corrosion phenomena.

In a variation of the invention comprising an outer housing, the outer housing has at least one fastening means. Such a fastening means may be used in order to mechanically interconnect the outer housing with another structure, such as a composite structure. Alternatively or in addition such a fastening means may be used in order to temporarily interconnect the outer housing to a forming tool which is used to produce such a composite structure. Alternatively or in addition such a fastening means may also be used in order to position a load application element accurately on a structure or in a forming tool.

Alternatively or in addition, the reinforcing element may comprise at least one fastening means to fasten the load application element to an external structure.

Alternatively or in addition, a load application element may comprise an outer housing which has a face shaped to align with an outer face of a certain structure. Hence such a variation of the invention may be attached to a structure by means of an adhesive and used for force introduction as an onsert.

Good results may be obtained if an outer housing is made using an injection molding process. Hence large-lot production of load application elements with reproducible mechanical characteristics and/or relatively complex outer geometries at reasonable prices may become possible.

Depending on the application, the reinforcing element may at least partially be made from a fiber reinforced plastic, a metal, a ceramic and combinations thereof. However, the invention is not limited to theses types of materials, and e.g. also plastics without fiber reinforcements may be used in combinations with other materials.

For some applications, an insert with a front pad and a rear pad, spaced a distance apart with respect to each other, may be at least partially embedded in the reinforcing element. Hence load distribution within the reinforcing element may be better controlled. Good results may be obtained if at least one intermediate pad is arranged between the front pad and the rear pad. A very good force distribution may be obtained if at least one layer of reinforcing fibers is arranged between the front pad and the rear pad.

In a variation of the invention, the reinforcing element is made from a material which has a low thermal conductivity as well as a high resistance against thermal damage. Such a variation of a load application element may be used in order to prevent a composite structure from being thermally damaged if it has to be mechanically linked to other structures which show at least temporarily elevated temperatures, such as brake systems.

The reinforcing element may comprise carbon fibers, glass fibers, aramide fibers, basalt fibers or combinations thereof.

In order to obtain force introducing elements with a low weight and high stiffness as well as anisotropic behavior (if desired) a plastic reinforced with long fibers may be used.

Good results may be obtained if the reinforcing element is made using a textile semi-finished product. Such a textile semi-finished product may e.g. be chosen from the group of pre-preg, biaxial fabric, triaxial fabric and quadraxial fabric.

In a variation of the invention, the reinforcing element may comprise multiple plies of textile semi-finished products, which themselves may be made from multiple plies, too. For some applications, textile semi-finished products may be woven fabrics. For other applications, good results may be obtained if stitch-bonded fabrics are used. Hence also reinforcing elements with relatively large spatial dimensions can be produced.

For some applications the reinforcing element may also be made by a tailored fiber placement (TFP) process. Such a variation of the invention may be advantageous in order to obtain a load application element with a highly complex outer geometry and/or predefined mechanical anisotropy.

For some applications the load application element may have a loading means that comprises an opening in the reinforcing element and/or a protrusion out of the reinforcing element which extends from the outer housing.

In a variation of the invention, the load application element may comprise a loading means that has a threaded bore in the reinforcing element. Depending on the application and the material used for the reinforcing element, the loading means may also comprise a bushing or threaded insert, such as a threaded bushing and/or a helical insert (screw thread insert), which is at least partially in the reinforcing element. Such threaded inserts may be made from a metal, such as e.g. steel, aluminum or titanium.

However, load application elements with a particularly low weight can be obtained if the load application element comprises a loading means that comprises a threaded bore which is an integral part of the reinforcing element, hence made from the same material as the reinforcing element. Threaded bores with a high mechanical competence may be obtained if the reinforcing element is already provided with a pilot hole during the production of the reinforcing element and a thread is cut afterwards, such as by using a tap.

In a variation of the present invention, the load application element may comprise a loading means that is at least partially embedded in the reinforcing element and extends from the reinforcing element. Such a variation of the invention may be advantageous in order to connect a structure to another using a pin connection (pin joint).

It is clear that a load application element according to the present invention is not limited to be used in combination with composite structures, but may also be used to introduce force in other types of structures.

A load application element according to the present invention may be produced using different methods.

According to a first variation of a method for producing a load application element according to the present invention, first a reinforcing element comprising several layers of a composite material is inserted into a mold. Subsequently an outer housing is made around this reinforcing element. Therefore injection and/or compression molding as well as thermoforming may be used. In such a variation of the invention the reinforcing element which is inserted in the mold may be an at least partially cured fiber reinforced plastic material.

According to a second variation of a method for producing a load application element according to the present invention, a reinforcing element comprising several layers of a composite material is inserted in an outer housing that has been produced in an antecedent step. The reinforcing element may be a dry textile semi-finished product. In a subsequent step, resin injection is performed in order to impregnate the reinforcing element with resin. In a variation of this method, the layers of this reinforcing element may be stitch-bonded or sewn together in order to prevent misalignment during subsequent steps. Alternatively or in addition, the multiple layers may be secured during resin injection.

### BRIEF DESCRIPTION OF THE DRAWINGS

The herein described invention will be more fully understood from the detailed description given herein below and the accompanying drawings, which should not be considered as limiting to the invention described in the appended claims.

FIG. 1 schematically shows a an embodiment of a load application element in a perspective view;

FIG. 2 schematically shows the load application element of FIG. 1 in a frontal view;

FIG. 3 shows cross-section A-A of FIG. 2;

FIG. 4 shows a cross-section similar to cross-section A-A for another embodiment of a load application element;

FIG. 5 shows a cross-section similar to cross-section A-A for another embodiment of a load application element;

FIG. 6 shows a cross-section similar to cross-section A-A for another embodiment of a load application element;

FIG. 7 shows a cross-section similar to cross-section A-A for another embodiment of a load application element;

FIG. 8 shows an embodiment of a load application element with a portion of it being clipped for illustrative purposes, in a perspective view;

FIG. 9 shows an embodiment of a textile semi-finished product which may be used as a reinforcing element;

FIG. 10 shows an embodiment of a load application element with a portion of it being clipped for illustrative purposes in a perspective view;

FIG. 11 shows the load application element of FIG. 9 mounted in a composite structure;

FIG. 12 shows an embodiment of a load application element which is fastened to a composite structure by means of connecting members;

FIG. 13 shows an embodiment of a load application element;

FIG. 14 shows an embodiment of a load application element;

FIG. 15 shows an embodiment of a load application element.

### DETAILED DESCRIPTION OF THE INVENTION

The foregoing summary, as well as the following detailed description of the preferred embodiments, is better understood when read in conjunction with the appended drawings. For the purposes of illustrating the invention, an embodiment that is presently preferred, in which like numerals represent similar parts throughout the several views of the drawings, it being understood, however, that the invention is not limited to the specific methods and instrumentalities disclosed.

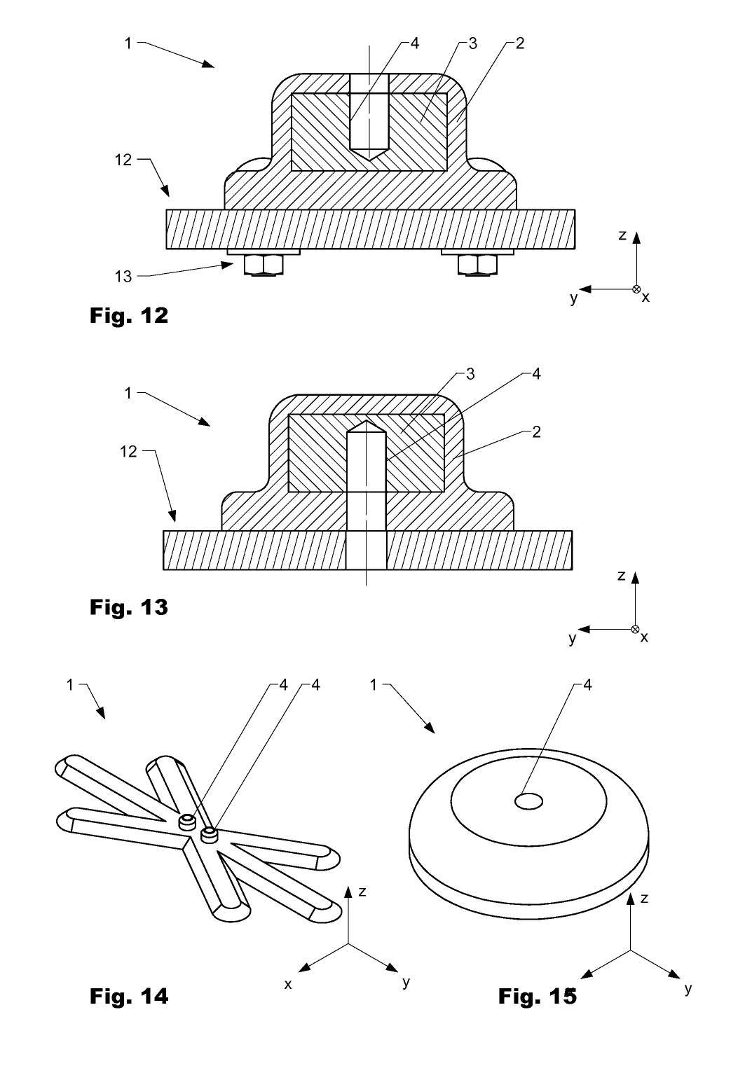

FIGS. 1 and 2 show an embodiment of a load application element 1 in a perspective view. The load application element 1 comprises an outer housing 1 which is made from a short-fibers reinforced plastic. The outer housing 2 comprises multiple fastening means 7 which may be used in order to mechanically interconnect the load application element 1 with a structure (not shown), as will be explained in FIG. 12. Such fastening means 7 may be used in order to position and preliminarily fix a load application element 1 to a composite structure (not shown) during the production of such a structure. Hence a proper positioning of the force introduction points of such a structure can be ensured. In addition, the embodiment of a load application element 1 shown in FIGS. 1 and 2 comprises an attachment face which has a shape (geometry) that aligns with a structure it has to be connected to. Hence the load application element 1 may e.g. be interconnected with such a structure by an adhesive film (not shown).

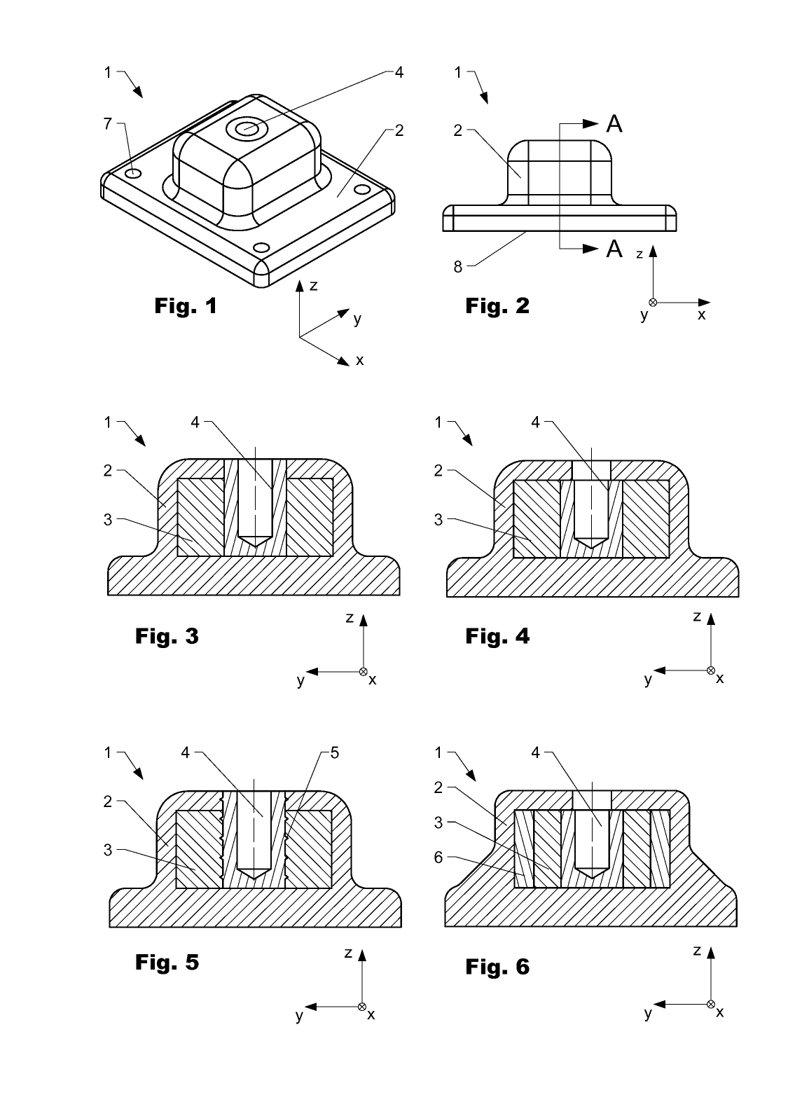

FIG. 3 shows cross-section A-A of FIG. 2. As illustrated, the embodiment of a load application element 1 shown comprises an inner reinforcing element 3 which is made from a long-fibers reinforced plastic. The reinforcing element 3 comprises multiple layers (layup in z-direction) of fibers, whereby the orientation of the fibers varies between the different layers. Within the reinforcing element 3, a loading means 4 is embedded, which in the embodiment shown is a threaded bushing.

FIG. 4 shows a cross-section of another embodiment of a load application element 1. In contrast to the embodiment shown in FIG. 3, the load application element 1 shown in FIG. 4 comprises a loading means which is also partially embedded in the outer housing 2, what may add additional pull-out strength to the loading means.

As shown in FIG. 5, a loading means 4 may on its surface also comprise a protrusion, such as teeth, or another type of locking means in order to improve its anchorage in the reinforcing element 3 by form-locking.

FIG. 6 illustrates another embodiment of a load application element 1 with an outer housing 2 that has a slightly different shape. Within the outer housing 2, a loading means 4 is embedded in a central reinforcing element 3 which itself is partially embedded in peripheral reinforcing element 6. Hence, in such an embodiment, load transmission, respectively force distribution may be controlled more efficiently.

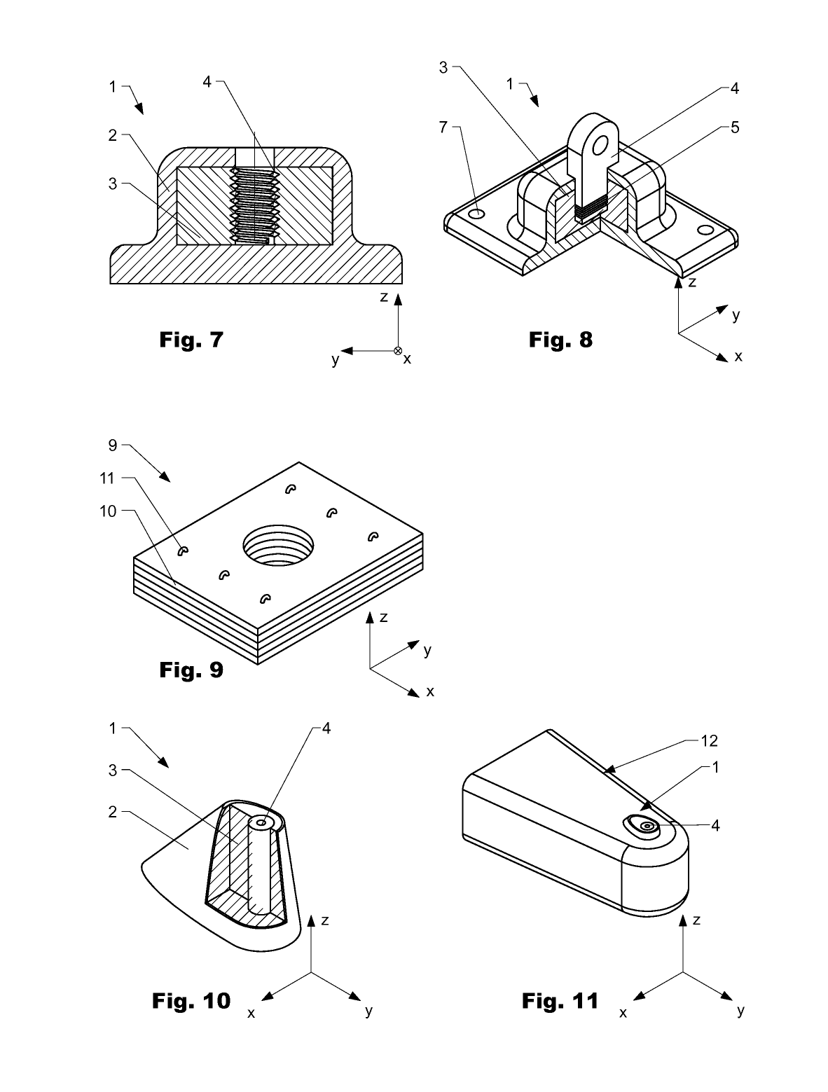

FIG. 7 shows another embodiment of a load application element 1 where the loading means 4 is a helical insert. Such types of loading means 4 can e.g. be used in order to obtain particularly lightweight load application elements 1, as thus the amount of relatively heavy metal components can be kept to a minimum. Thus, depending on the application, helical inserts may be made from steel alloys which are electrochemically compatible with e.g. carbon fibers and hence can be used in combination with reinforcing elements 3 comprising carbon fibers.

FIG. 8 shows another embodiment of a load application element 1 whereof a part has been clipped in order to illustrate its inner structure. In this embodiment of the invention, the loading means 4 significantly protrudes from the outer housing 2. The loading means 4 also comprises protrusions 5 which improve its anchorage in the reinforcing element 3. Such an embodiment of a load application element 1 may e.g. be used in order to establish a pin joint to an external structure (not shown).

FIG. 9 shows a variation of textile semi-finished product 9 which may be used in order to produce a reinforcing element 3 for a load application element 1 according to the present invention. This type of textile semi-finished product 9 comprises multiple plies (layers) 10 of textiles that comprise reinforcing fibers (not shown in detail). The plies 10 are stitch-bonded by multiple stitches 11. Thus misalignment of the plies of the textile semi-finished product 9 during the production process of a load application element can be prevented.

FIGS. 10 and 11 show another embodiment of a load application element 1, whose shape/geometry as well as mechanical properties are adapted to a composite structure 12. The load application element 1 has an oval cross section which varies in z-direction. When mounted, the load application element is partially embedded in the composite structure, as can be seen in FIG. 11.

FIG. 12 shows another embodiment of load application element 1 which is mounted on the surface of a composite structure 12. The force introduction element and the composite structure are connected by means of connecting members 13 which are screws positioned in the fastening means. The loading means 4 is a thread which is directly cut in the reinforcing element 3. Hence the loading means 4 is made from the same material as the reinforcing element 3, respectively is integrally formed with the reinforcing element 3.

FIG. 13 shows an embodiment of a load application element 1 which can be engaged through a bore in the composite structure 21.

FIGS. 14 and 15 show two other embodiments load application elements 1 according to the invention with different geometries. The load application element 1 shown in FIG. 14 is essentially star-shaped and comprises two loading means 4. Such embodiments may e.g. be advantageous in order to distribute applied loads over a larger area, taking anisotropy of an adjacent composite structure into account. The load application element 1 shown in FIG. 15 has an essentially cylindrical shape and only one loading means 4.

### NUMBERS

1 Load application element
2 Housing
3 Reinforcing element
4 Loading means
5 Protrusions
6 Peripheral reinforcing element
7 Fastening means
8 Attachment face
9 Textile semi-finished product
10 Ply
11 Stitch
12 Composite structure
13 Connecting member

1. A load application element comprising:
a. at least one reinforcing element comprising a layered setup from several layers of a composite material; and
b. an outer housing which encompasses the reinforcing element at least partially.

2. The load application element according to claim 1, wherein a loading means is mechanically interconnected to and/or incorporated in the at least one reinforcing element.

3. The load application element according to claim 2, wherein the loading means is a thread or a bushing arranged at least partially in the reinforcing element.

4. The load application element according to claim 2, wherein the loading means is made from a metal or a ceramic or plastic, or a fiber reinforced plastic.

5. The load application element according to claim 1, wherein the outer housing comprises at least one fastening means to fasten the load application element to an external structure.

6. The load application element according to claim 1, wherein the reinforcing element comprises at least one fastening means to fasten the load application element to an external structure.

7. The load application element according to claim 1, wherein the load application element is embedded in a wall of a structure made at least partially from a composite material.

8. The load application element according to claim 1, wherein the reinforcing element has a rectangular, circular, pyramidal, oval, or star-like shape.

9. The load application element according to claim 1, wherein the outer housing comprises ribs.

10. The load application element according to claim 1, wherein the outer housing is made from an injection and/or compression and/or thermoformed plastic material.

11. The load application element according to claim 1, wherein in a section view the outer housing encompasses the reinforcing element on at least two sides.

12. The load application element according to claim 1, wherein the housing is made from a plastic material comprising short fibers.

13. The load application element according to claim 1, wherein the at least one reinforcing element comprises a fiber reinforced plastic which comprises long fibers.

14. The load application element according to claim 1, wherein the at least one reinforcing element comprises carbon fibers and/or glass fibers, and/or aramide fibers, and/or basalt fibers.

15. The load application element according to claim 1, wherein the at least one reinforcing element comprises multiple layers of a textile semi-finished product.

16. The load application element according to claim 15, wherein the multiple layers are stitch-bonded or sewn together.

17. A method for producing a load application element according to claim 1, comprising the steps of:
a. providing an outer housing;
b. inserting a dry textile semi-finished product into the outer housing; and
c. impregnating the dry textile semi-finished product by resin injection.

18. The method for producing a load application element according to claim 17, wherein the dry textile semi-finished product comprises at least one opening which is used to position the textile semi-finished product in the forming tool.

19. The method for producing a load application element according to claim 18, wherein the at least one opening is provided with a thread.

20. A method for producing a load application element according to claim 1, comprising the steps of:
a. inserting a reinforcing element made from an at least partially cured fiber reinforced plastic material into a forming tool;
b. closing the forming tool; and
c. injecting material into the forming tool to form an outer housing.
